(19) United States
(12) Patent Application Publication
(10) Pub. No.: US 2010/0085157 A1
(43) Pub. Date: Apr. 8, 2010

(54) METHOD FOR PROVIDING SERVICE USING RFID TAG IDENTIFIER IN RFID SYSTEM AND APPARATUS THEREOF

(75) Inventors: Sang-Keun Yoo, Chungcheongnam-do (KR); Jun-Seob Lee, Daejeon-city (KR); Yong-Woon Kim, Cheonan-city (KR); Hyoung-Jun Kim, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-city (KR)

(21) Appl. No.: 12/441,334

(22) PCT Filed: Oct. 26, 2006
(86) PCT No.: PCT/KR06/04391

§ 371 Date: Mar. 13, 2009

(30) Foreign Application Priority Data
Sep. 14, 2006 (KR) 10-2006-0089262

(51) Int. Cl. H04Q 5/22

(52) U.S. Cl. 340/10.1

(57) ABSTRACT

A method and an apparatus for providing a service using an RFID tag identifier in an RFID system are provided. The method includes: identifying the RFID tag for providing the service; acquiring an object identifier and a unique item identifier from the RFID tag and determining whether or not each of the identifiers can be interpreted; and disregarding the RFID tag if either of the identifiers cannot be interpreted, and determining whether or not the service should be provided according to validity of the tag identifier of the RFID tag if both of the identifiers can be interpreted. In addition, directly after interpreting the unique item identifier stored in the RFID tag, instead of providing information searches or service, an operation of determining whether or not the tag identifier of the RFID tag is used or issued by an RFID system is performed using the tag identifier stored in the RFID tag. Accordingly, it is possible to prevent the RFID tag issued intentionally or by mistake and having the same object identifier and unique item identifier stored in the RFID tag from receiving erroneous operations or unsuitable service.

### TECHNICAL FIELD

The present invention relates to a method and an apparatus for providing a service using a tag identifier, an object identifier, and a unique item identifier stored in a radio frequency identification (RFID) tag.

This work was supported by the IT R&D program of MIC/IITA[2006-P10-08, RFID/USN Standardization].

### BACKGROUND ART

Radio frequency identification (RFID) tags are widely used in distribution industries, where they are attached to products. Techniques are being developed for allowing a person who purchases a product with an RFID tag attached to continuously use the RFID tag without removing it. Other techniques are being developed for providing a mobile RFID service using a personal portable terminal with the RFID tag attached.

In order to acquire information or provide a service using an RFID tag, an RFID system uses a tag identifier to select the RFID tag. Subsequently, the RFID system acquires an object identifier and a unique item identifier stored in the RFID tag. If the object identifier is determined to be interpretable, an operation of interpreting the object identifier and the unique item identifier is performed. FIG. 1 is a diagram showing the tag identifier 101, the object identifier 103, and the unique item identifier 105 stored in the RFID tag 100 in the RFID system. In general, when the RFID tag is manufactured, the unique tag identifier 101 is uniquely recorded in the RFID tag, and cannot be altered. When an RFID reader of the RFID system identifies the RFID tag, the RFID tag provides the tag identifier 101 to the RFID reader of the RFID system. Therefore, the RFID system does not perform an additional operation of verifying the tag identifier 101 to determine whether or not the tag identifier 101 corresponds to the RFID tag which the RFID system uses.

When the object identifier 103 and the unique item identifier 105 read from the RFID tag are interpretable, it is possible to acquire information about the RFID tag or to provide the service using the interpreted unique item identifier 105. On the other hand, if the RFID tag stores only the unique item identifier 105 without the object identifier 103, the same processes as described above are performed except for the operation of interpreting the object identifier 103.

However, the conventional method has the following shortcomings. The object identifier 103 and the unique item identifier 105 stored in the RFID tag should have specific forms which the RHO system uses for a specific service. If a foreign RFID tag stores an object identifier and a unique item identifier similar to the object identifier 103 and the unique item identifier 105 of the RFID tag which the specific RFID system uses, whether intentionally or not, the RFID system cannot determine whether or not the RFID tag has been validly issued by the RFID system.

For example, when an RFID system is used for processing airline luggage, an RFID tag may be attached to luggage bound for destination A. However, if the luggage contains an item having an RFID tag with an object identifier and a unique item identifier similar to the object identifier 103 and the unique item identifier 105 of the RFID tag for the luggage, and the unique item identifier indicates that the luggage should be sent to destination B, the RFID system can incorrectly send the luggage to destination B instead of A.

### DESCRIPTION OF THE DRAWINGS

FIG. 1 is a diagram showing a tag identifier, an object identifier, and a unique item identifier stored in an RFID tag;

FIG. 2 is a block diagram showing an apparatus for providing a service using an RFID tag identifier in an RFID system according to an embodiment of the present invention;

FIG. 3 is a flowchart showing a method for providing a service using an RFID tag identifier in an RFID system according to another embodiment of the present invention; and

FIG. 4 is a flowchart showing a method for providing a service using an RFID tag identifier in an RFID system according to another embodiment of the present invention.

### DETAILED DESCRIPTION OF THE INVENTION

### Technical Problem

The present invention provides a method and an apparatus for providing a service by determining whether or not a radio frequency identification (RFID) tag is valid and issued by an RFID system, using an object identifier, a unique item identifier, and a tag identifier stored in the RFID tag.

### Technical Solution

According to an aspect of the present invention, there is provided a method for providing a service using an RFID tag identifier in an RFID system, comprising: (a) identifying an RFID tag for providing the service; (b) acquiring an object identifier and a unique item identifier from the RFID tag and determining whether or not each of the identifiers can be interpreted; and (c) disregarding the RFID tag if either of the identifiers cannot be interpreted, and determining whether or not the service should be provided according to the validity of the RFID tag identifier if both of the identifiers can be interpreted.

According to another aspect of the present invention, there is provided a method for providing a service using an RFID tag identifier in an RFID system, comprising: (a) identifying an RFID tag for providing the service; (b) determining whether or not the tag identifier of the RFID tag is valid; and (c) acquiring an object identifier and a unique item identifier from the RFID tag if the tag identifier of the RFID tag is valid, determining whether or not each of the identifiers can be interpreted, and determining that service should be provided if both of the identifiers can be interpreted.

According to another aspect of the present invention, there is provided an apparatus for providing a service using an RFID tag identifier in an RFID system, comprising: a tag storage unit storing tag identifiers of RFID tags which the RFID system uses or issues; a first determining unit extracting at least one identifier from the RFID tag to determine whether or not the identifier can be interpreted; a second determining unit determining that if a tag identifier is detected in the tag storage unit then the tag identifier is valid when the first determining unit determines that the identifier can be interpreted; and a service determining unit determining that service should be provided to the RFID tag if the first determining unit determines that the identifier can be interpreted, and if the second determining unit determines that the tag identifier of the RFID tag is valid.

### Advantageous Effects

As described above, according to a method and an apparatus for providing a service using an RFID tag identifier in an RFID system, since the tag identifier of the RFID tag is used to determine whether or not the service is provided, the RFID system avoids erroneous operations and prevents the RFID tag from receiving unsuitable service even when others store the same information as an object identifier and a unique item identifier used by the RFID system, whether intentionally or by mistake.

### Best Mode

According to an aspect of the present invention, there is provided a method for providing a service using an RFID tag identifier in an RFID system, comprising: (a) identifying an RFID tag for providing the service; (b) acquiring an object identifier and a unique item identifier from the RFID tag and determining whether or not each of the identifiers can be interpreted; and (c) disregarding the RFID tag if either of the identifiers cannot be interpreted, and determining whether or not the service should be provided according to the validity of the RFID tag identifier if both of the identifiers can be interpreted.

### Mode of the Invention

Hereinafter, exemplary embodiments of the present invention will now be described in detail with reference to the attached drawings.

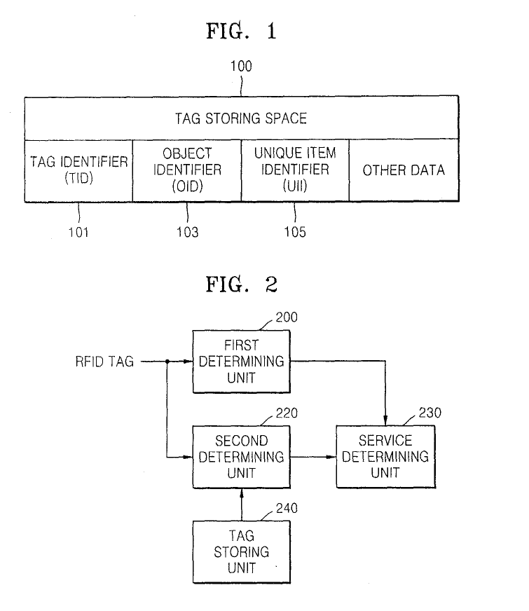

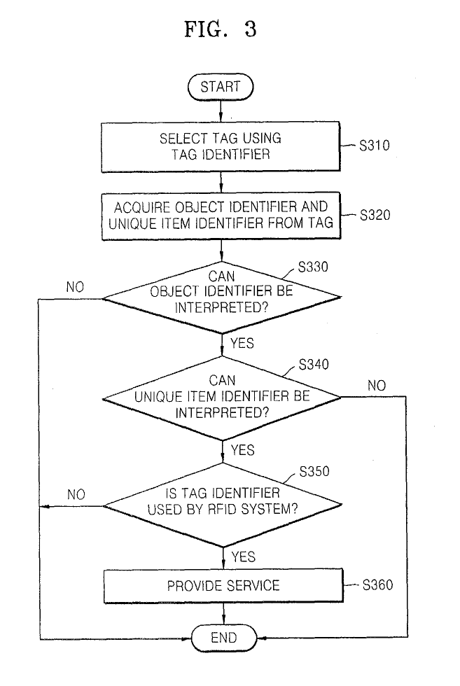

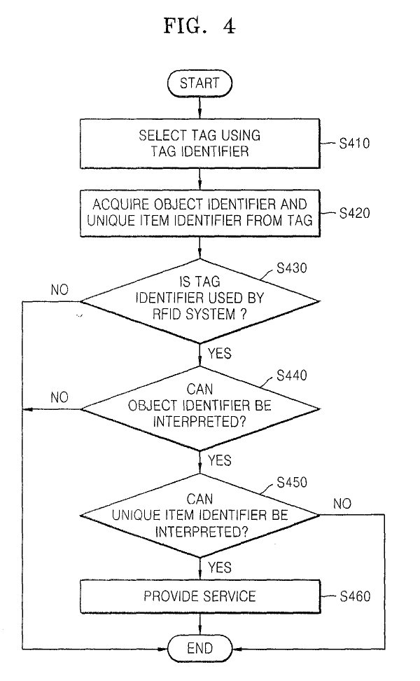

FIG. 2 is block diagram showing an apparatus for providing a service using a radio frequency identification (RFID) tag identifier in an RFID system according to an embodiment of the present invention. FIG. 3 is a flowchart showing a method for providing a service using an RFID tag identifier in an RFID system according to another embodiment of the present invention. FIG. 4 is a flowchart showing a method for providing a service using an RFID tag identifier in an RFID system according to another embodiment of the present invention.

Referring to FIG. 3, an RFID reader of the RFID system selects an RFID tag from any identifiable RFID tags using the tag identifier 101 in operation S310.

The RFID reader acquires an object identifier 103 and a unique item identifier 105 from the selected RFID tag in operation S320.

The RFID system determines whether the object identifier 103 acquired from the RFID tag can be interpreted in operation S330, proceeds to the next operation if the object identifier 103 can be interpreted, and disregards the RFID tag if the object identifier 103 cannot be interpreted.

If the object identifier 103 acquired from the RFID tag can be interpreted, the RFID system determines whether or not the unique item identifier 105 can be interpreted in operation S340. The RFID system proceeds to the next operation if the unique item identifier 105 can be interpreted and disregards the RFID tag if the unique identifier cannot be interpreted.

If the unique item identifier 105 acquired from the RFID tag can be interpreted, the RFID system compares the tag identifier of the RFID tag with tag identifiers stored in a tag identifier storage space of the RFID system or another RFID system associated with the RFID system in operation S350. The tag identifier storage space is a separate storage unit which stores the tag identifiers of the RFID tags used or issued by the RFID system. If the tag identifier acquired from the RFID tag is detected in the tag identifier storage space, the RFID tag is a valid tag. Therefore, the RFID system proceeds to the next operation. On the other hand, if the tag identifier acquired from the RFID tag is not detected in the tag identifier storage space, but it is not a valid tag of the RFID system or another RFID system associated with the RFID system even though the object identifier 103 and the unique item identifier 105 are valid. Therefore, the RFID system disregards the RFID tag.

If the object identifier 103 and the unique item identifier 105 acquired from the RFID tag can be interpreted, and if the tag identifier is detected in the tag identifier storage space, the RFID system provides a service in operation S360.

FIG. 4 is a flowchart showing a method for providing a service using an RFID tag identifier in an RFID system according to another embodiment of the present invention.

An RFID reader of the RFID system selects an RFID tag from any identifiable RFID tags using the tag identifier in operation S410.

The RFID reader acquires an object identifier and a unique item identifier from the selected RFID tag in operation S420.

The RFID system compares the tag identifier of the selected RFID tag with tag identifiers stored in a tag identifier storage space of the RFID system or another RFID system associated with the RFID system in operation S430. As described above, the tag identifier storage space is a separate storage unit which stores the tag identifiers of the RFID tags used or issued by the RFID system. If the tag identifier acquired from the RFID tag is detected in the tag identifier storage space, the RFID tag is a valid tag. Therefore, the RFID system proceeds to the next operation. On the other hand, if the tag identifier acquired from the RFID tag is not detected in the tag identifier storage space, it is not a valid tag of the RFID system or another RFID system associated with the RFID system. Therefore, the RFID system disregards the RFID tag.

If the tag identifier of the selected RFID tag is detected in the tag identifier storage space, the RFID system determines whether or not the object identifier acquired from the RFID tag can be interpreted in operation S440. The RFID system proceeds to the next operation if the object identifier can be interpreted and disregards the RFID tag if the object identifier cannot be interpreted.

If the tag identifier of the selected RFID tag is detected in the tag identifier storage space, and if the object identifier acquired from the RFID tag can be interpreted, the RFID system determines whether or not the unique item identifier can be interpreted in operation S450. The RFID system proceeds to the next operation if the unique item identifier can be interpreted and disregards the RFID tag if the unique item identifier cannot be interpreted.

If the tag identifier of the selected RFID tag is detected in the tag identifier storage space, and if the object identifier and the unique item identifier acquired from the RFID tag can be interpreted, the RFID system provides a service in operation S460.

An apparatus for providing a service using an RFID tag identifier in an RFID is system according to an embodiment of the present invention will now be described in detail with reference to FIG. 2.

A tag storage unit 240 stores tag identifiers of RFID tags which are being used or have previously been issued by the RFID system. In addition, the tag storage unit 240 also stores information about RFID tags which are being used or have previously been issued by another RFID system associated with the RFID system.

A first determining unit 200 extracts a tag identifier, an object identifier, and a unique item identifier from the RFID tag to determine whether or not the identifiers can be interpreted. The first determining unit 200 reads the object identifier and the unique item identifier from the RFID tag, determines whether or not the object identifier can be interpreted first, and then determines whether or not the unique item identifier can be interpreted. Alternatively, the first determining unit 200 may first determine whether or not the unique identifier can be interpreted and then determine whether or not the object identifier can be interpreted.

If the first determining unit 200 determines that the identifiers can be interpreted, and if the tag identifier is detected in the tag storage unit 240, a second determining unit 220 determines that the tag identifier of the RFID tag is valid.

If the first determining unit 200 determines that the identifiers can be interpreted, and if the second determining unit 220 determines that the tag identifier of the RFID tag is valid, a service determining unit 230 determines that a service should be provided for the RFID tag.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (for example, transmissions through the internet). The computer readable recording medium can also be distributed over network coupled computer systems, so that the computer readable code is stored and executed in a distributed fashion.

As described above, the present invention has been particularly shown and described with reference to exemplary embodiments thereof. The exemplary embodiments should be considered in a descriptive sense only, and not for purposes of limitation. Therefore, it will be understood by those skilled in the art that various is changes in form and detail may be made therein without departing from the spirit and scope of the invention as defined by the appended claims. Therefore, the scope of the invention is defined not by the detailed description of the invention but by the appended claims, and all differences within the scope will be construed as being included in the present invention.

1. A method for providing a service using an RFID (radio frequency identification) tag identifier in an RFID system, comprising:
(a) identifying an RFID tag for providing the service;
(b) acquiring an object identifier and a unique item identifier from the RFID tag and determining whether or not each of the identifiers can be interpreted; and
(c) disregarding the RFID tag if either of the identifiers cannot be interpreted, and determining whether or not the service should be provided according to the validity of the RFID tag identifier if both of the identifiers can be interpreted.

2. The method of claim 1, wherein in (b), the determining of whether or not each of the identifiers can be interpreted is performed by determining whether or not the object identifier can be interpreted, and then determining whether or not the unique item identifier can be interpreted.

3. The method of claim 1, wherein (c) comprises determining that the tag identifier of the RFID tag is valid if the RFID tag identifier is detected by searching for tag identifiers which are previously acquired and stored in the RFID system.

4. A method for providing a service using an RFID tag identifier in an RFID system, comprising:
(a) identifying an RFID tag for providing the service;
(b) determining whether or not the tag identifier of the RFID tag is valid; and
(c) acquiring an object identifier and a unique item identifier from the RFID tag if the tag identifier of the RFID tag is valid, determining whether or not each of the identifiers can be interpreted, and determining that service should be provided if both of the identifiers can be interpreted.

5. The method of claim 4, wherein (b) comprises determining that the tag identifier of the RFID tag is valid if the RFID tag identifier is detected by searching for tag identifiers which are previously acquired and stored in the RFID system.

6. The method of claim 4, wherein (c) comprises:
(c1) disregarding the RFID tag if the object identifier cannot be interpreted;
(c2) determining whether or not the unique item identifier can be interpreted if the object identifier can be interpreted; and
(c3) according to the result of (c2), disregarding the RFID tag if the unique item identifier cannot be interpreted, and determining that service should be provided if the unique item identifier can be interpreted.

7. The method of claim 1, prior to (a), further comprising acquiring tag identifiers of RFID tags used or issued by the RFID system or another RFID system associated with the RFID system.

8. An apparatus for providing a service using an RFID tag identifier in an RFID system, comprising:
a tag storage unit storing tag identifiers of RFID tags used or issued by the RFID system;
a first determining unit extracting at least one identifier from the RFID tag to determine whether or not the identifier can be interpreted;
a second determining unit determining that if a tag identifier is detected in the tag storage unit then the tag identifier is valid when the first determining unit determines that the identifier can be interpreted. and
a service determining unit determining that service should be provided to the RFID tag if the first determining unit determines that the identifier can be interpreted, and if the second determining unit determines that the tag identifier of the RFID tag is valid.

9. The apparatus of claim 9, wherein the tag storage unit stores the tag identifiers of RFID tags used or issued by another RFID system associated with the RFID system as well as the tag identifiers of RFID tags used or issued by the RFID system.

10. The apparatus of claim 8, wherein the first determining unit reads an object identifier and an unique item identifier from the RFID tag, determines whether or not the object identifier can be interpreted, and determines whether or not the unique item identifier can be interpreted.
